(19) United States
(12) Patent Application Publication
(10) Pub. No.: US 2018/0181978 A1
(43) Pub. Date: Jun. 28, 2018

(54) SYSTEM AND METHOD TO PROVIDE A REWARD DURING A CASHLESS TRANSACTION

(71) Applicant: MASTERCARD INTERNATIONAL INCORPORATED, Purchase, NY (US)

(72) Inventors: Henry M. Weinberger, New York, NY (US); Roopa A. Vaidya, Pleasantville, NY (US); Nigel Noyes, Irvington, NY (US); Matthew Haisley, Monroe, NY (US); Gaurav Kumar, Ahmedabad (IN)

(21) Appl. No.: 15/391,263

(22) Filed: Dec. 27, 2016

(51) Int. Cl. G06Q 30/02; G06Q 50/00; G06Q 20/34

(52) U.S. Cl. CPC G06Q 30/0212; G06Q 20/34; G06Q 50/01; G06Q 30/0226

(57) ABSTRACT

A system and method to provide a reward during a cashless transaction, i.e., in real-time, that is immediately applied to the cashless transaction to reduce the amount due from a customer. The system and method link the reward to a group comprised of the customer and his/her friends, family, colleagues, and adds a gaming aspect to a rewards program in that there is a possibility that a cardholder wins a reward each time he/she uses the credit card. The system and method calculates a probability value for the customer and/or for the group, generates a random number for the cashless transaction, and provides a reward if the random number and probability value are the same.

### FIELD OF THE INVENTION

The present invention relates to a system and method to provide a reward during a cashless transaction.

### BACKGROUND OF THE INVENTION

Companies are continuously looking for ways to distinguish their products or services from their competitors. They are also looking for ways to increase customer loyalty, hopefully increasing customer purchases of their products or services. The importance and value of customer loyalty is very important in a highly competitive marketplace. One way to increase customer loyalty is for a company to provide rewards to customers for repeatedly buying the company's products. Customer expectations as to the type or rewards and the manner in which the rewards are delivered varies, typically as technology advances and new and different ways to deliver rewards are developed. For example, rewards that are more closely linked to the actual customer experience (i.e., experience-focused rewards) are displacing more traditional loyalty programs (e.g., paper coupons, in-store sales, etc.). This holds true for services as well as for products. For example, credit cards may offer rewards programs to encourage their customers to use their credit cards more often. However, a typical credit card customer may belong to many rewards programs, in some cases multiple rewards programs for a single credit card. Consequently, traditional rewards program can have a diminishing return on customer loyalty. Moreover, rewards of this type are not linked to any activity of other credit card users, such as friends, family, colleagues, i.e., a person's social connections.

In addition, traditional rewards programs are typically not linked with specific cashless transactions or uses of a credit card. Rather, these rewards programs may provide for after-sales rewards in the form of a credit to the credit card account of a percentage of the total amount spent by the customer using the credit card.

For a company to distinguish itself from its competition, and to succeed in crowded and highly competitive environments, it must develop and implement novel rewards programs that overcome the above-described shortcomings.

### SUMMARY OF THE INVENTION

The present invention is directed to a system and method to provide a reward during a cashless transaction that overcomes the above-described shortcomings. The present invention provides a reward during a cashless transaction, i.e., in real-time, that is immediately applied to the cashless transaction to reduce the amount due from the customer. In addition, the present invention links the reward to a group comprised of the customer and his/her friends, family, colleagues, etc., i.e., his/her social network. The present invention adds a gaming aspect to a rewards program in that there is a possibility that a cardholder wins a reward each time he/she uses the credit card. Consequently, the present invention is distinguishable from known rewards programs.

In an embodiment of the present invention, a cardholder registers for the rewards program and creates his/her personal rewards group. The cardholder may then invite others to join the group and participate in the rewards program. The present invention calculates a probability value for the group and for each member of the group. If the member is confirmed to belong to a group, he/she will receive the group probability value. If the member does not belong to a group, he/she will receive an individual probability value. The probability value is used, at least in part, to determine whether a member of the group will receive a rewards during a cashless transaction. In calculating the probability value, the present invention considers the group profile that may include, by way of illustration and not limitation, the number of members of the group, their individual and collective spending history, and an anticipated value to the various cashless transaction card issuers represented in the group from the collective spending of the group. In an embodiment of the present invention, the probability value will be proportional to the number of members in the group—the more members, the higher the probability that a member will receive a reward.

The present invention provides a reward program for cashless transactions using a cashless transaction card that is more like a game than traditional rewards programs. The gaming aspect lies in the possibility that a reward will be provided for a randomly selected transaction, where the probability of winning is fixed for the group in which the cardholder is a member. A cardholder never knows when he/she will receive a reward, presenting the element of surprise during a cashless transaction. When a reward is provided in accordance with embodiments of the present invention, a cardholder receives, in real time during the cashless transaction, a reduction in the cost of the transaction that may be as much as the total amount of the transaction, resulting in the possibility that the cardholder receives the goods or services for free. With the possibility that a cardholder may receive a reward that pays for a cashless transaction, it is expected that the cardholder may be more likely to use a cashless transaction card account that utilizes the rewards program in accordance with embodiments of the present invention. Thus the present invention combines real-time delivery of a reward and the sticking power of a social circle with what is normally an individual financial transaction to create a unique rewards program and approach to customer loyalty.

An embodiment of the present invention is directed to a system to provide a reward during a cashless transaction between a merchant and a customer using a cashless transaction card account number. The system comprises a server having a processor operable by a program of instructions stored in memory and a database accessible by the server and containing a database record for a group comprised of at least one member. The database record comprises an entry containing a cashless transaction account number for the at least one member. The program of instructions, when executed by the server processor, causes the server processor, during the cashless transaction, to receive a request to authorize a cashless transaction for the customer cashless transaction account number and determine if there is an entry in the database for the customer cashless transaction account number. When there is an entry in the database for the customer cashless transaction account number, the program of instructions, when executed by the server processor, further causes the server processor, during the cashless transaction, to determine a probability value for the group, generate a random number, determine if the random number is one of less than and equal to the probability value, and if the random number is one of less than and equal to the probability value, transmit to one of the merchant and the customer, during the cashless transaction, data to modify a term of the cashless transaction.

The present invention is further directed to a system to provide a reward during a cashless transaction between a merchant and a customer using a cashless transaction card account number, wherein the database record for the group further comprises a probability value, and wherein the program of instructions, when executed by the server processor, causes the server processor to determine a probability value for the group by obtaining the probability value from the database record.

The present invention is further directed to a system to provide a reward during a cashless transaction between a merchant and a customer using a cashless transaction card account number, wherein the program of instructions, when executed by the server processor, causes the server processor to determine a probability value for the group by calculating the probability value.

The present invention is further directed to a system to provide a reward during a cashless transaction between a merchant and a customer using a cashless transaction card account number, wherein the program of instructions, when executed by the server processor, further causes the server processor to calculate the probability value based upon the number of members in the group.

The present invention is further directed to a system to provide a reward during a cashless transaction between a merchant and a customer using a cashless transaction card account number, wherein the probability value is proportional to the number of members in the group.

The present invention is further directed to a system to provide a reward during a cashless transaction between a merchant and a customer using a cashless transaction card account number, wherein the probability value is calculated as a ratio of an expected daily value of the group and the value of a typical transaction for the group.

The present invention is further directed to a system to provide a reward during a cashless transaction between a merchant and a customer using a cashless transaction card account number, wherein the program of instructions, when executed by the server processor, further causes the server processor to determine the probability value based upon a change in the group. The present invention is further directed to a system to provide a reward during a cashless transaction between a merchant and a customer using a cashless transaction card account number, wherein the group has a spending history and wherein the change in the group comprises one of a change in the number of members in the group, passage of a period of time, and a change in the spending history.

The present invention is further directed to a system to provide a reward during a cashless transaction between a merchant and a customer using a cashless transaction card account number, wherein the data to modify the term of the cashless transaction changes the amount of the cashless transaction by one of reducing the amount and reducing the amount to zero.

The present invention is further directed to a system to provide a reward during a cashless transaction between a merchant and a customer using a cashless transaction card account number, wherein, if the random number is one of less than and equal to the probability value, the program of instructions, when executed by the server processor, further causes the server processor to calculate an amount of a reward, and to transmit to one of the merchant and the customer, during the cashless transaction, data to subtract the amount of the reward from the amount of the cashless transaction.

Another embodiment of the present invention is directed to a method for providing a reward during a cashless transaction between a merchant and a customer using a cashless transaction card account number. The inventive method comprises, during a cashless transaction, receiving a request to authorize a cashless transaction for the customer cashless transaction account number, accessing a database containing a database record for a group comprised of at least one member, the database record comprising an entry containing a cashless transaction account number for the at least one member, and determining if there is an entry in the database for the customer cashless transaction account number. When there is an entry in the database for the customer cashless transaction account number, the method further comprises determining a probability value for the group, generating a random number, determining if the random number is one of less than and equal to the probability value, and if the random number is one of less than and equal to the probability value, transmitting to one of the merchant and the customer, during the cashless transaction, data to modify a term of the cashless transaction.

The present invention is further directed to a method for providing a reward during a cashless transaction between a merchant and a customer using a cashless transaction card account number, the method further comprising determining a probability value for the group by obtaining the probability value from the database record.

The present invention is further directed to a method for providing a reward during a cashless transaction between a merchant and a customer using a cashless transaction card account number, the method further comprising determining a probability value for the group by calculating the probability value.

The present invention is further directed to a method for providing a reward during a cashless transaction between a merchant and a customer using a cashless transaction card account number, the method further comprising calculating the probability value based upon the number of members in the group.

The present invention is further directed to a method for providing a reward during a cashless transaction between a merchant and a customer using a cashless transaction card account number, the method further comprising calculating the probability value that is proportional to the number of members in the group.

The present invention is further directed to a method for providing a reward during a cashless transaction between a merchant and a customer using a cashless transaction card account number, the method further comprising calculating the probability value as a ratio of an expected daily value of the group and the value of a typical transaction for the group.

The present invention is further directed to a method for providing a reward during a cashless transaction between a merchant and a customer using a cashless transaction card account number, the method further comprising calculating the probability value based upon a change in the group. The present invention is further directed to a method for providing a reward during a cashless transaction between a merchant and a customer using a cashless transaction card account number, wherein the group has a spending history and wherein the change in the group comprises one of a change in the number of members in the group, passage of a period of time, and a change in the spending history.

The present invention is further directed to a method for providing a reward during a cashless transaction between a merchant and a customer using a cashless transaction card account number, the method further comprising transmitting to one of the merchant and the customer, during the cashless transaction, data to modify a term of the cashless transaction by one of reducing the amount and reducing the amount to zero.

The present invention is further directed to a method for providing a reward during a cashless transaction between a merchant and a customer using a cashless transaction card account number, wherein, if the random number is one of less than and equal to the probability value, the method further comprises calculating an amount of a reward, and transmitting to one of the merchant and the customer, during the cashless transaction, data to subtract the amount of the reward from the amount of the cashless transaction.

### DESCRIPTION OF THE DIAGRAMS

Embodiments of the present invention will now be described with reference to the following figures, wherein:

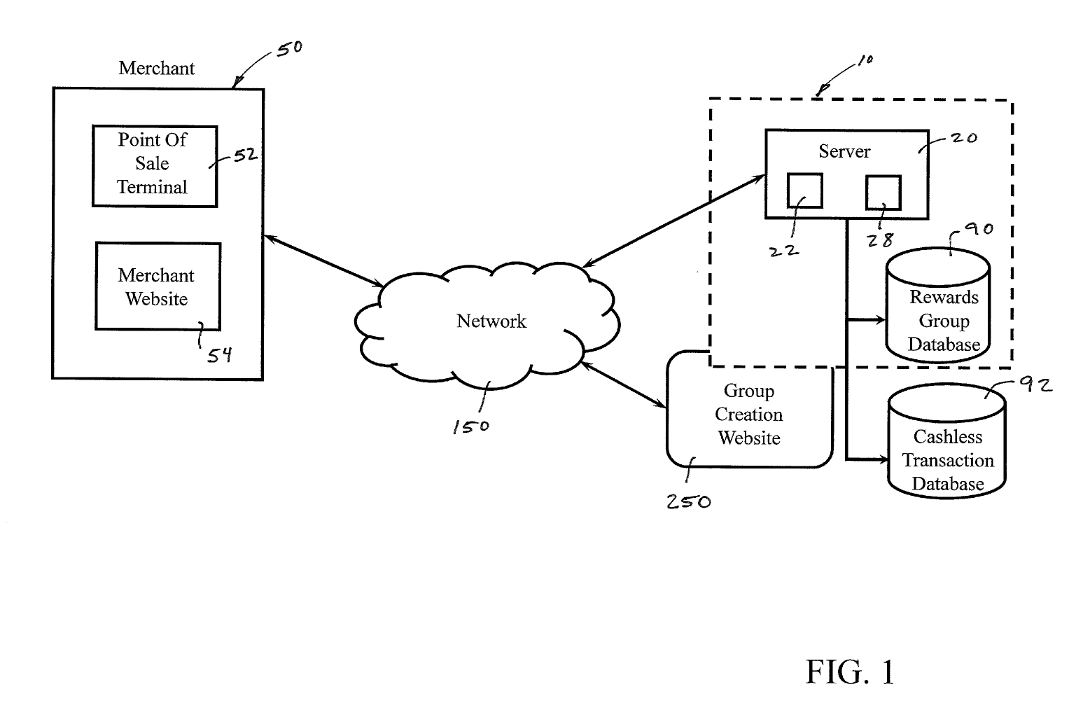

FIG. 1 depicts a system to provide a reward during a cashless transaction in accordance with embodiments of the present invention;

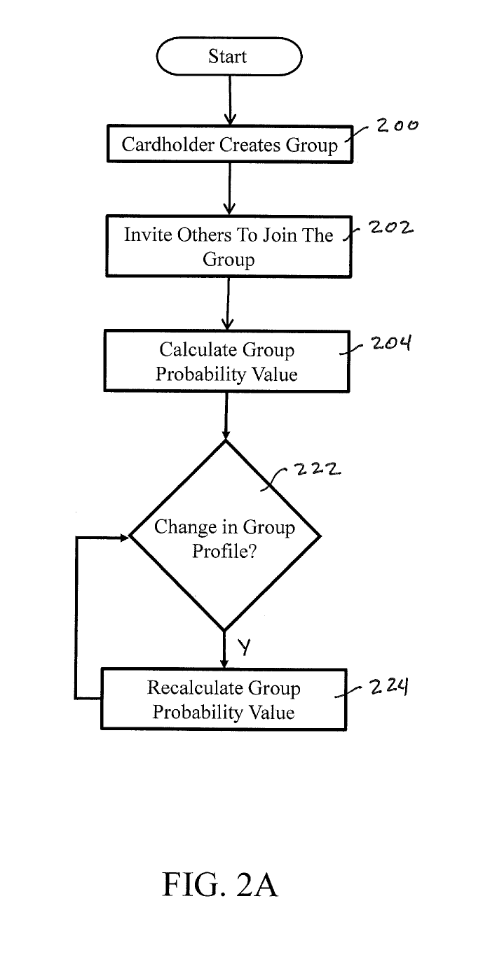

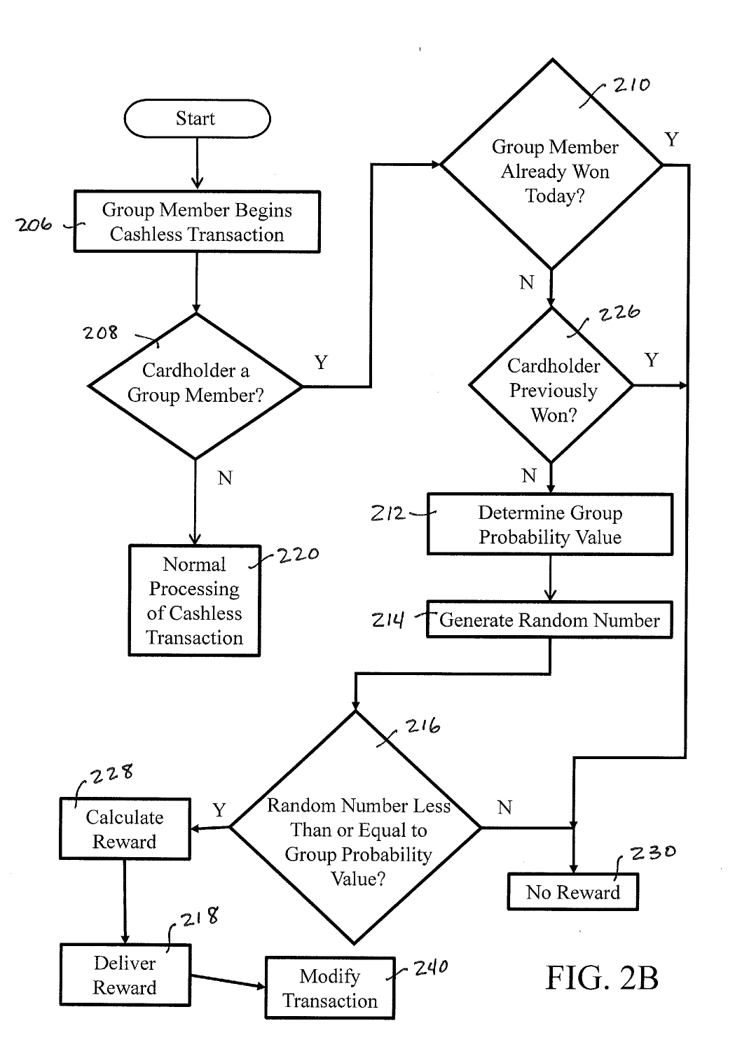

FIG. 2A is a flow diagram for creating a rewards group in accordance with embodiments of the present invention;

FIG. 2B is a flow diagram for determining whether a reward is provided during a cashless transaction and in accordance with embodiments of the present invention;

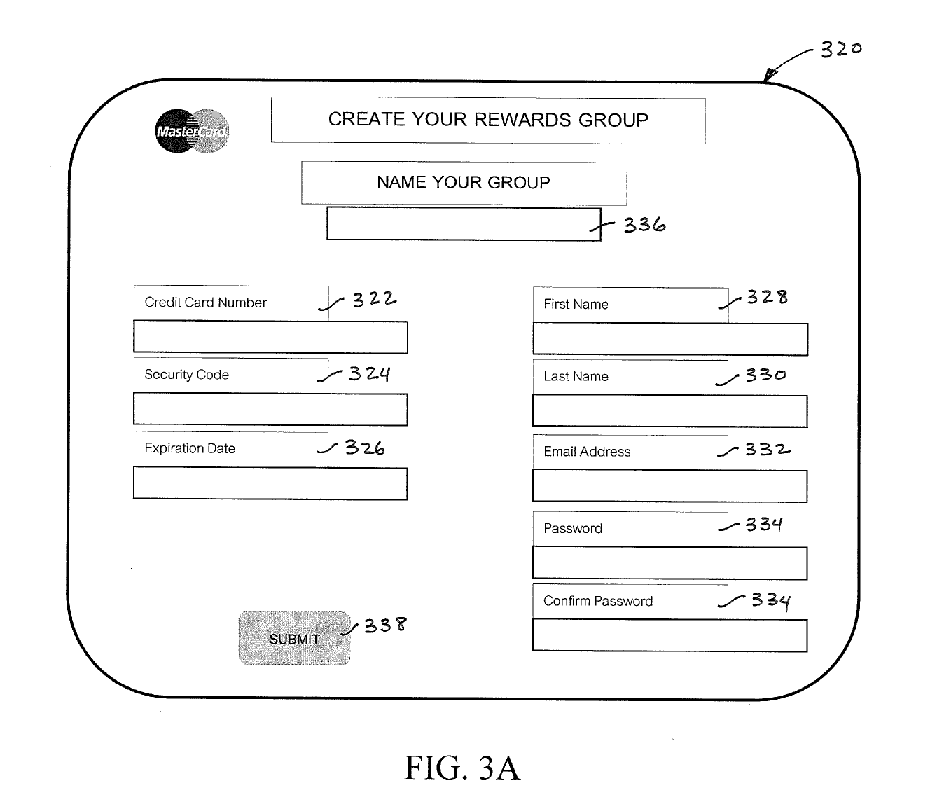

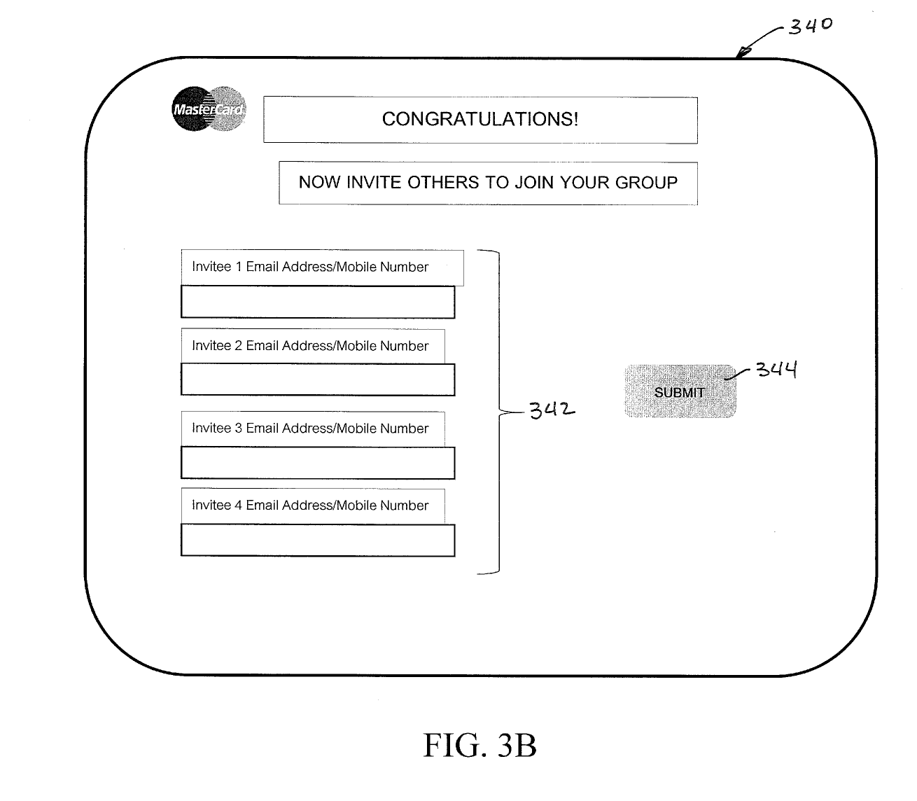

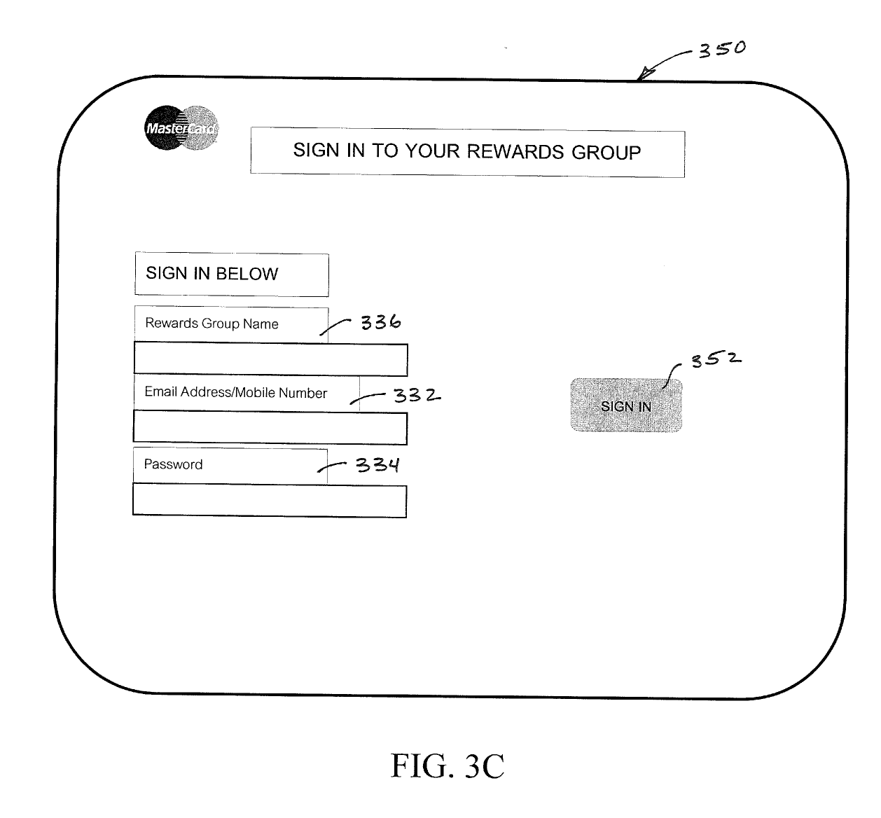

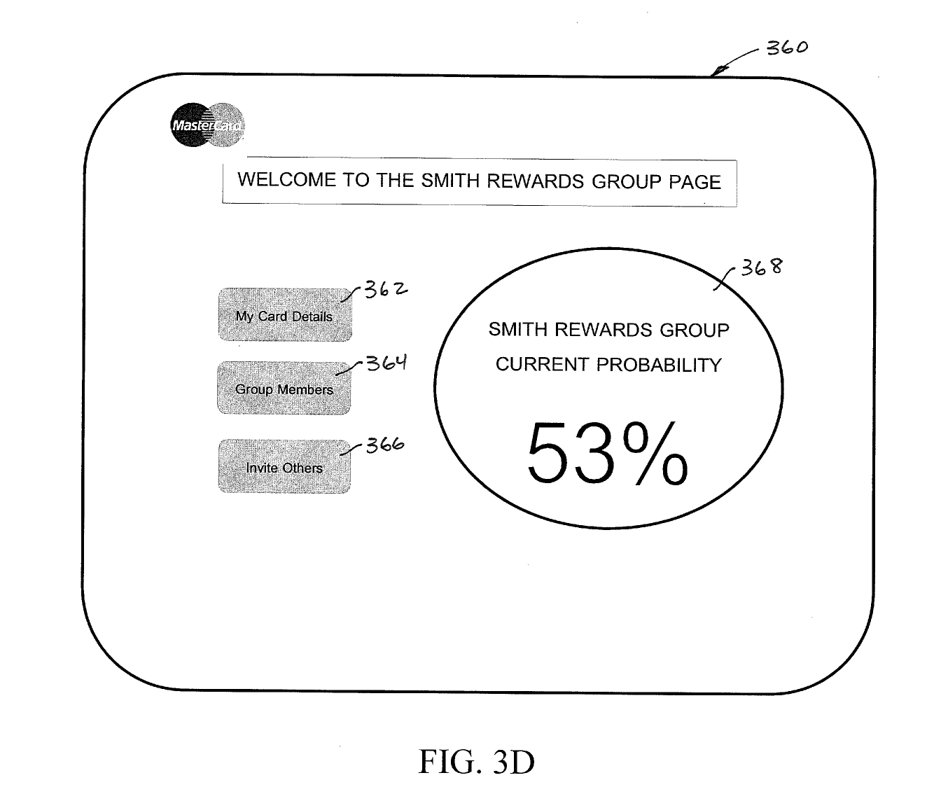

FIG. 3A depicts a web page for creating a rewards group in accordance with embodiments of the present invention;

FIG. 3B depicts a web page for inviting others to join a rewards group in accordance with embodiments of the present invention;

FIG. 3C depicts a web page for signing into a rewards group in accordance with embodiments of the present invention;

FIG. 3D depicts a web page for a rewards group in accordance with embodiments of the present invention;

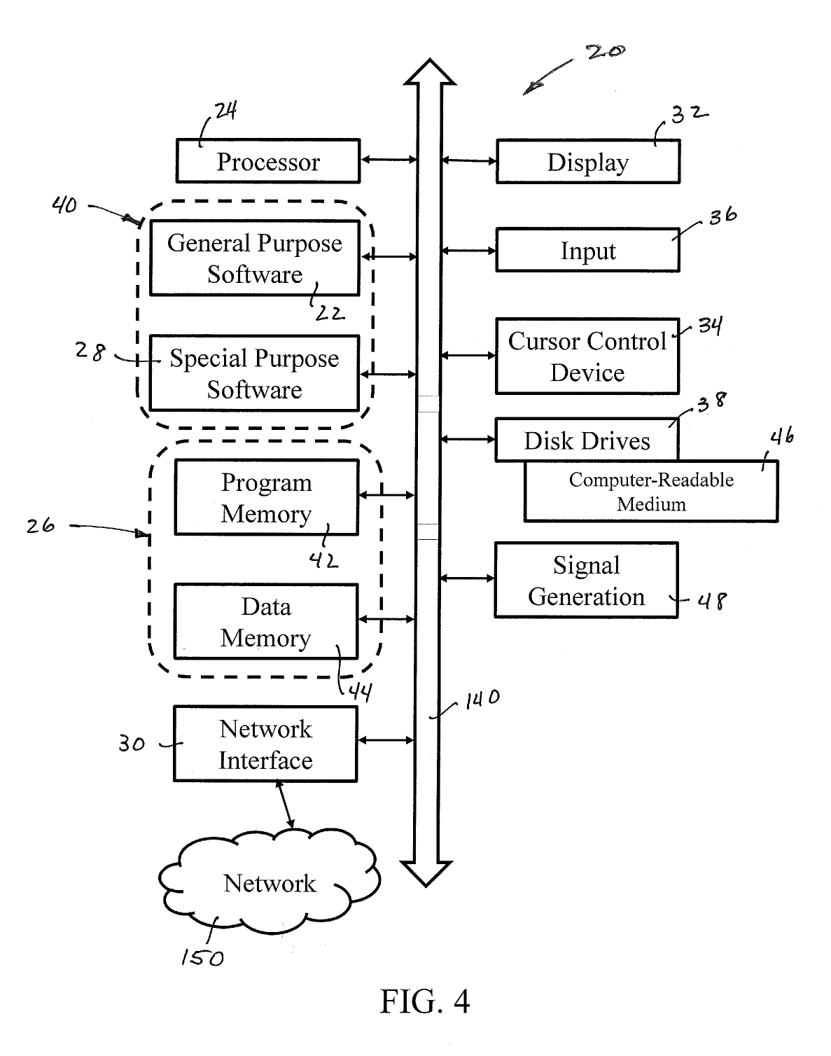

FIG. 4 is a block-diagram schematic of a server in accordance with embodiments of the present invention; and

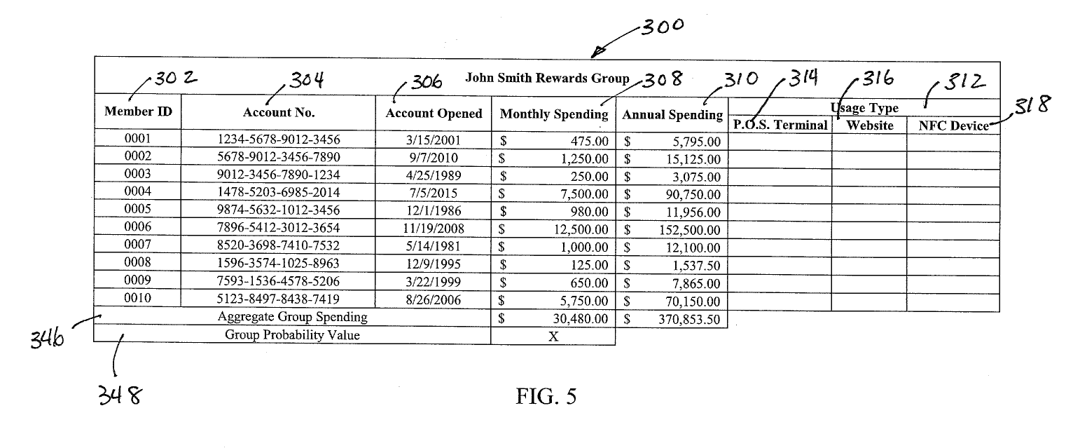

FIG. 5 is an illustrative example of a database record for a rewards group in accordance with embodiments of the present invention.

### DESCRIPTION OF EMBODIMENTS OF THE INVENTION

The following describes exemplary embodiments of the present invention. It should be apparent to those skilled in the art that the described embodiments of the present invention are illustrative only and not limiting, having been presented by way of example only. All features disclosed in this description may be replaced by alternative features serving the same or similar purpose, unless expressly stated otherwise. Therefore, numerous and various other embodiments are contemplated as falling within the scope and spirit of the present invention.

As used herein the term “cashless transaction” refers to a transaction between at least a merchant and a customer or cardholder (the terms customer and cardholder being used interchangeably herein) using a cashless transaction account number associated with a cashless transaction card or cashless transaction account. Typically, an issuer of the cashless transaction card account number is also involved in the transaction to authorize the transaction, to provide payment to the merchant, and to manage the customer's cashless transaction account. The cashless transaction may be initiated using a cashless transaction card or other payment device at a merchant location, using a cashless transaction number associated with a cashless transaction card via a merchant website, or using a device like a smartphone capable of carrying out a NFC cashless transaction with a cashless transaction account number.

As used herein, the term “cashless transaction card” includes, by way of illustration and not limitation, a credit card, debit card, prepaid card, gift card, and other similar cards. References to a cashless transaction card are also intended to refer to an account and account number associated with the cashless transaction card. Thus, reference to a cashless transaction card herein does not only refer to the physical card, but also to the account and account number for that card. As used herein, the term “cashless transaction device” incudes an electronic or electro-mechanical device capable of carrying-out aspects of a cashless transaction including, by way of illustration and not limitation, a smart phone, a tablet, a laptop computer, and other similar electronic or electro-mechanical devices.

As used herein, the term “connectable” refers to various states of connection between electronic devices. For example, “connectable” refers to a physical connection between electronic devices, a wireless connection between electronic devices, a combination of a physical and wireless connection between electronic devices, or a transient or episodic connection between electronic devices. As used herein the term “connectable” also refers to various states of connectivity between electronic devices such as, by way of non-limiting example, when electronic devices are not connected, when electronic devices are connecting, and when electronic devices are connected.

The present invention is directed to a system and method for providing a reward to a cardholder during a cashless transaction. The cardholder, having prior to the cashless transaction created or become a member of a rewards group, is thereafter eligible to receive a reward for using a cashless transaction card or account number (e.g., for cashless transactions conducted on-line and using a device such as a smart phone). As a member of a rewards group, each time a cardholder uses his/her cashless transaction card or account number, the present invention determines whether to reward the cardholder. The reward is applied in real-time during a cashless transaction to modify at least a term of the transaction. For example, the reward may be a fixed dollar amount that is applied during the cashless transaction to reduce the amount the cardholder pays for the goods and/or services being bought during the transaction. The probability that a cardholder member of a rewards group will receive a reward during a cashless transaction may be fixed, at least during the cashless transaction, and depends, at least on part, on the group profile, that may include the number of members in the group and their respective shopping history (e.g., how often they use the cashless transaction card or account number that is registered to the rewards group, how much they spend on each transaction, on average, in the aggregate, etc.), and anticipated value of the group and of the transaction to the issuer from the collective spending of the group. Groups in accordance with the present invention are not static, but can vary in size (i.e., the number of members of the group), spending history and patterns, etc. Consequently, although the probability value for each rewards group may be fixed for periods of time, it may be recalculated as the dynamics of the group changes. For example, adding to or losing members from the group will affect the probability value of the group. Also, as the size of the group changes, so does the group profile and the probability value. For those members that are new or have insufficient shopping history, a statistical model based on available credit history and/or demographic variables or geodemographic variables may be used to create a cardholder profile. The present invention also provides safeguards against fraud and abuse by ensuring that only one member from a rewards group can receive a reward each day, and that each member of the reward group cannot receive a reward twice in a row. Safeguards against fraud may also be provided by traditional credit checks, by ensuring that accounts in group are not being continuously opened/closed, and/or by monitoring timing between purchase and returns to ensure that purchase are not being made and then returned if the cardholder does not win.

The present invention may be implemented in a cashless transaction network via which various parties can carry-out a cashless transaction. Typical parties include a cardholder, a merchant, an acquirer, and an issuer. As used herein, the term “acquirer” refers to a bank that processes and settles a merchant's cashless transactions. As used herein, the term “issuer” refers to a financial institution, bank, credit union or company that issues cashless payment transaction cards to cardholders. An issuer may assist an acquirer with processing and settling a merchant's cashless transactions. In a typical cashless transaction, a cardholder initiates a cashless transaction using a cashless transaction card at the merchant location via a point of sale terminal, or via a merchant website over the Internet. Alternatively, the cardholder may use a mobile device to carry out the cashless transaction, either at the merchant location using NFC, for example, or via the merchant website. The cardholder's cashless transaction number is transmitted by the merchant to the acquirer, and then onto the issuer to determine whether to authorize the transaction based upon the cardholder's available credit, amount of the transaction, etc. If the issuer approves the transaction, an authorization code is transmitted from the issuer to the acquirer, and then to the merchant. Upon receipt, the merchant will conclude the transaction and provide the product to the cardholder.

Referring first to FIG. 1, an illustrative configuration of a system 10 in accordance with embodiments of the present invention is depicted. The system 10 comprises a server 20 connectable to a network 150 that may be any known or hereafter developed network such as, by way of illustration and not limitation, a local area network (“LAN”), the Internet, a wireless network, a cellular network, and variations and combinations thereof.

The server 20 has installed and operational thereon general purpose software 22 to carry-out traditional functions of a server (see, e.g., discussion of FIG. 4, below), and special purpose software 28 to carry-out aspects of the present invention, as discussed in more detail herein. The special purpose software 28 renders the server 20 a special purpose computing device insofar as the special purpose software 28 is operably controlling certain functions of the server 20 directed to the present invention. The present invention is thus aimed at solving the technical problem of delivering a reward to a cardholder member of a rewards group in real-time during a cashless transaction, where the probability that the cardholder or any other member of the rewards group will receive a reward is based, at least in part, upon the group profile. The certain functions of the server 20 controlled by the special purpose software 28 are aimed at solving this technical problem which is only possible in accordance with the present invention by the special purpose software 28 together with the general purpose software 22 and server 20 over the network 150.

The system 10 includes a rewards group database 90 containing separate database entries for each of a plurality of rewards groups. A sample, illustrative database entry 300 for a group is depicted in FIG. 5. The rewards database 90 will contain a plurality of database entries as depicted in FIG. 5, each entry being for a separate rewards group. The database entry 300 for each rewards group further comprises a plurality of entries, each for a member of the group. The plurality of entries may include, by way of illustration and not limitation, a Member ID 302, Account Number 304 for the associated member's cashless transaction account, an Account Opened date 306, Monthly Spending 308 and Annual Spending 310 amounts, and the number of times each member uses his/her cashless transaction card for different Usage Type 312, including at a P.O. S. Terminal 314, Website 316 and NFC Device 318. Other usage types are contemplated by, and within the scope and spirit of the present invention. As noted above, the group profile may include the number of members of the group and their individual and collective spending history, or Aggregate Group Spending 346. As the number of members of the group changes, and as their individual and collective spending changes, so too will the group profile and the calculated Group Probability Value 348 in accordance with embodiments of the present invention.

The system 10 also has access to a cashless transaction database 92 that includes a plurality of database entries for a plurality of cashless transactions carried out using a plurality of cashless transaction cards. Information in this database 92 provides spending insights about a cardholder including where the cardholder shops most often (e.g., merchants, websites, etc.), the type of products the cardholder buys most often, and other data obtainable from the historical use of the cashless transaction card.

The server 20 is connectable via the network 150 to at least one point of sale terminal 52 of a merchant 50 that facilitates cashless transactions between the merchant 50 and its customers. The server 20 is also connectable via the network 150 to a merchant website 54 via which a customer may purchase products from the merchant 50 over the network 150. The customer can initiate a cashless transaction using a cashless transaction card at the merchant location via the point of sale terminal 52, or via the merchant website 54 over the Internet (i.e., the network 150). Alternatively, the customer may use a mobile device to carry out the cashless transaction, either at the merchant location using NFC, for example, or via the merchant website 54. The customer mobile device may be a cell phone, smart phone, iPad, tablet, or any other now known or hereafter developed device that enables a user to send and receive information of any type over a network and that is capable of carrying-out a cashless transaction.

With continued reference to FIG. 1, and additional reference to FIG. 4, a server 20 in accordance with embodiments of the present invention will now be discussed in more detail. The server 20 may be a general purpose computing device having a plurality of devices and components operably connected over a bus 140. The server 20 has one or more processors 24 or central processing units (“CPU”). Although the server 20 of the present invention is discussed as having a single processor 20, a server having multiple processors, either separate or integrated in a multi-core processor, for example, are also contemplated by and within the scope and spirit of the present invention. Reference to processor in the singular herein shall be interpreted to include any variation and number of processors. The processor 24 is operable by at least one program of instructions 40 comprising general purpose software 22 to carry out functions that enable the server 20 to interface with its various hardware components (discussed further below), and to interface and communicate with other devices. The processor 24 of the present invention is also operable by at least one program of instructions 40 comprising special purpose software 28 to carry out aspects of the present invention. The general purpose software 22 and special purpose software 28 may be stored on the server 20 in memory 26 that may comprise program memory 42 and data memory 44, or it may be stored on one or more disk drives 38 comprised of a computer-readable medium 46, or it may be stored in/on any combination of the foregoing. As used herein, the term “memory” is intended to include all currently known or hereafter developed types of permanent or temporary storage devices or components in a computing device. Exemplary memory types include, by way of illustration and not limitation, Random Access Memory (RAM)—further including Dynamic RAM (DRAM), Static RAM (SRAM), and Direct Rambus DRAM (DRDRAM), Read Only Memory (ROM)—further including Programmable ROM (PROM), erasable PROM (EPROM), and Electrically EPROM (EEPROM), cache memory, hard drives and flash memory.

The server 20 further includes a display 32 (e.g., liquid crystals display (LCD), a flat panel, a solid state display, or a cathode ray tube (CRT)), input device(s) 36 (e.g., a keyboard), cursor control device(s) 34 (e.g., a mouse), signal generation device(s) 48 (e.g., a speaker or remote control), and network interface device(s) 30 that enable the server 20 to selectively connect to and with a network 150, and to send or receive voice, video or data, and to communicate over the network 150 as controlled by the program of instructions 40.

The memory 26 and disk drives 38 each comprise computer-readable medium that may each include a single medium or multiple media (e.g., a centralized or distributed database, and/or associated caches and servers) that store the one or more sets of instructions 40. As used herein, the term “computer-readable medium” means and includes, but is not limited to, solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives that is considered a distribution medium equivalent to a tangible storage medium. Accordingly, the embodiment is considered to include anyone or more of a tangible computer-readable medium or a tangible distribution medium, as listed herein and including art-recognized equivalents and successor media, in which the software implementations herein are stored. The term “computer-readable medium” also means and includes any medium that is capable of storing, encoding, or carrying a set of instructions in the general purpose software 22 and in the special purpose software 28 and used thereby to create a rewards group.

With reference next to FIGS. 2A and 3A-3D, further aspects of the present invention will now be discussed in greater detail. As a first step, at 200, a cardholder must create a rewards group. Accessing a group creation website 250 (FIG. 1) provided by the special purpose software 28, a cardholder will access a group creation web page 320 such as that depicted in FIG. 3A. To create a new rewards group a cardholder must enter, via the group creation web page 320, certain personal information including, by way of illustration and not limitation, a Group Name 336, the cardholder's Credit Card Number 322, Security Code 324, Expiration Date 326, First Name 328, Last Name, 330, Email Address 332 and Password/Confirm Password 334. Once this information is entered the cardholder may select Submit 338 and the information from the web page 320 is received by the special purpose software 28.

Once the rewards group is created, the cardholder is prompted, at 202, to invite other members to the group via the web page 340 depicted in FIG. 3B. Here again the cardholder is prompted to enter the Email address and/or mobile phone number for each invitee 342, and click on the submit button 344. The invitees will then receive an invitation via email and/or text to join the rewards group. Once a person is a member of a rewards group he/she will have access to certain information about the group. For example, each group member can login to the rewards group via a login web page 350, as depicted in FIG. 3C, and access certain information about the group. A member must provide login information like the Group Name 336, the member's login credentials, such as Email address and/or mobile phone number 332 and Password 334, to access the rewards group. Once the member has entered the information and selected Sign In 352, the member proceeds to the member's rewards group web page 360, as depicted in FIG. 3D. This web page provides a dashboard for the rewards group that provides members with access to certain information about their respective cashless transaction account and other members of the group. For example, each group member may be able to see the then-current probability for the group 368, access that member's credit card account 362, see information about other group members 364, and invite others to join the group 366.

With reference again to FIG. 2A, once the reward group is created, the special purpose software, at 204, calculates a probability value for the group. The probability that a cardholder member of a rewards group will receive a reward during a cashless transaction may be fixed, at least during the cashless transaction, and depends, at least in part, on the group profile, that may include the number of members in the group and their individual and collective shopping history (e.g., how often they use the cashless transaction card or account number that is registered to the rewards group, how much they spend on each transaction, on average, in the aggregate, etc.), and anticipated value to the issuer(s) represented in the group by the collective spending of the group. For those members that are new or have insufficient shopping history, a statistical model based on available credit history and/or demographic variables or geodemographic variables may be used to create a cardholder profile.

The probability that a cardholder member of a rewards group will receive a reward during a cashless transaction is determined using an algorithm that considers the ratio of an expected daily value of a rewards group and the value of a typical transaction for the group or for a region for any given day. The expected daily value can be determined by considering the annual amount of spending by each member of the group divided by 365—assuming each member has one year of spending history. Likewise, the aggregate spending for the group can be similarly calculated by adding the annual amount of spending for all members of the group and dividing this amount by 365 (again, assuming all members of the group have one year of spending history). For groups having more than one member, the latter method is used. This calculus produces a numerator used in calculating the probability value for the group.

The denominator is calculated by determining the value of a typical transaction for the group. Dividing the total value for all transactions for the group by the number of transactions produces an average or typical transaction value for the group. Obviously for a group with a single member, only that member's data is used. The probability value is calculated by dividing the expected daily value by the typical transaction value.

By way of example, if the expected daily value for the group is $0.10 and the value of a typical transaction is $100, the probability value is $0.10/$100=0.001, or 1 in a 1000. If more members are in the group and the expected daily value increases to $0.20, then the probability of winning increases to 0.002 or 1 in 500.

In an embodiment of the present invention, the probability value will be proportional to the number of members in the group—the more members, the higher the probability that a member will receive a reward. The special purpose software 28 monitors each group to detect changes in a group's profile. If a change is detected at 222, the probability value for that group is recalculated at 224 to account for the changes in the group's profile. For example, if members join or leave the group, the probability value is recalculated and will increase and decrease, respectively. If the spending patterns of members of the group changes, the probability value is recalculated and will also change. In general, because each rewards group is dynamic in its size and spending habits and patterns, changes in the group profile will initiate a recalculation of the probability value by the special purpose software 28. The trigger for such a recalculation can be any of the passage of time, a change on the spending activity of individual members of the group or of the group as a whole, or other changes to the group profile. Importantly, one of the safety measures of the present invention prevents a member from winning twice in a row, and two members from the same group winning in the same day. To accomplish this, the present invention sets the probability value to zero for the entire group after a member of the group has won, and to zero for a member of the group after that member has won. Once the day has ended, the probability value for the group is recalculated and reset for the following day.

Once a rewards group has been created, the special purpose software 28 monitors cashless transactions for members of the rewards group, as shown in FIG. 2B. When a group member begins a transaction at 206, the special purpose software 28 compares the cashless transaction account number presented for this cashless transaction against the rewards group database 90 to determine, at 208, if the cardholder, i.e., if the cashless transaction account number, is a member of a rewards group. If the cardholder is not a member of the group, the cashless transaction proceeds, at 220, without further involvement of the present invention. If, on the other hand, the cashless transaction account number is found in the rewards database 90, the special purpose software, at 210, determines whether any member of the rewards group has already received a reward on the same day as the current cashless transaction. If a group member has already won, then no reward is provided at 230 (because the probability value for the group was set to zero, as noted above). This aspect of the present invention can prevent a group member or multiple members of a group to attempt to intentionally cause a reward to be generated for more than one cashless transaction in a single day. If no other member of the group has received a reward on the same day, the special purpose software 28 proceeds, at 226, to determine if the cardholder is the same as the last group member to receive a reward. If it is, the cashless transaction proceeds without further involvement of the present invention (because the probability value for this specific cardholder was set to zero, as noted above). This prevents a cardholder for receiving a reward twice in a row. If, on the other hand, the cardholder is not the same as the immediately preceding winner, the special purpose software 28 proceeds, at 212, to determine the probability value for the group. As this may be generally considered a fixed value for each cashless transaction, it may have been determined prior to the initiation of a cashless transaction, and may be a part of the database entry 300 for the rewards group. Alternatively, the special purpose software 28 may calculate, in real-time during the cashless transaction, a probability value for the group based upon the latest available group profile. In either case, the special purpose software 28, at 214, next generates a random number between zero and one, and determines, at 216, whether the random number is less than or equal to the probability value, in which case a reward will be calculated, or whether the random number is greater than the probability value, in which case no reward is calculated. If the random number is less than or equal to the probability value, a reward is calculated at 228 and transmitted, at 218, to the merchant over the network 150, and/or to the cardholder via email, text, or other way of transmitting data and information. Once received by the merchant and/or cardholder, the reward is useable to modify a term of the transaction, at 240. For example, the reward may be for a fixed dollar amount to be deducted from the total amount due from the cardholder for the transaction. That dollar amount can be any amount, up to and including the total amount for the transaction (i.e., a 100% reward), or for any amount less than the total. The percentage of the total transaction amount that will be rewarded (i.e., the amount of the reward) may be based upon the value of the transaction to the issuer.

The amount of the reward is calculated based upon the value of a typical transaction for a rewards group. The special purpose software 28 monitors the cashless transactions for each rewards group, and calculates rewards based upon the value of these transactions to ensure that providing rewards does not have negative revenue implications for the issuer providing the reward.

Although the present specification may describe components and functions implemented in the embodiments with reference to particular standards and protocols, the disclosed embodiments are not limited to such standards and protocols.

In accordance with various embodiments, the present invention may be implemented as one or more software programs running on one or more computing devices and one or more computer processors. Dedicated hardware implementations including, but not limited to, application specific integrated circuits, programmable logic arrays and other hardware devices can likewise be constructed to implement the present invention. Furthermore, alternative software implementations including, but not limited to, distributed processing or component/object distributed processing, parallel processing, or virtual machine processing can also be constructed to implement the present invention.

Modifications to embodiments of the present invention are possible without departing from the scope of the invention as defined by the accompanying claims. Expressions such as “including,” “comprising,” “incorporating,” “consisting of,” “have,” “is,” used to describe and claim the present invention are intended to be construed in a non-exclusive manner, namely allowing for articles, components or elements not explicitly described herein also to be present. Reference to the singular is to be construed to relate to the plural, where applicable.

Although specific example embodiments have been described, it will be evident that various modifications and changes may be made to these embodiments without departing from the broader scope of the inventive subject matter described herein. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This description, therefore, is not to be taken in a limiting sense, and the scope of various embodiments is defined only by the appended claims, along with the full range of equivalents to which such claims are entitled.

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may generally be referred to herein as a “server,” “computing system,” “computer system,” “system,” etc. It is commonly known in the art these devices are associated with one or more processors or central processing units. Furthermore, the present invention may take the form of a computer program product embodied in any tangible medium of expressing having computer usable program code embodied in the medium.

Computer program code or applications for carrying out operations of the present invention may be written in any combination of one or more programming languages, including an object-oriented programming language such as Java, Smalltalk, C++, or the like and conventional procedural programming languages, such as Visual Basic, “C,” or similar programming languages. The program code or application may execute entirely on the customer's, payment instrument holder's, or user's personal computing device, partly on the user's personal computing device, as a stand-alone software package, partly on the user's personal computing device and partly on a remote server and/or other computing device, or entirely on the remote computer or server.

The present invention is described herein with reference to flowchart illustrations and/or block diagrams of methods, apparatuses (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer programmable instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provides processes for implementing the functions/acts specified in the flowchart and/or block diagram block or blocks.

What is claimed is:

1. A system to provide a reward during a cashless transaction between a merchant and a customer using a cashless transaction account number, the system comprising:
a database containing a database record for a group comprised of at least one member, the database record comprising an entry containing a cashless transaction account number for the at least one member;
a server having a processor operable by a program of instructions stored in memory, the database being accessible by the server, wherein the program of instructions, when executed by the server processor, causes the server processor, during the cashless transaction, to:
receive a request to authorize a cashless transaction for the customer cashless transaction account number;
determine if there is an entry in the database for the customer cashless transaction account number;
when there is an entry in the database for the customer cashless transaction account number, determine a probability value for the group;
generate a random number;
determine if the random number is one of less than and equal to the probability value; and
if the random number is one of less than and equal to the probability value, transmit to one of the merchant and the customer, during the cashless transaction, data to modify a term of the cashless transaction.

2. A system according to claim 1, wherein the database record for the group further comprises a probability value, and wherein the program of instructions, when executed by the server processor, causes the server processor to determine a probability value for the group by obtaining the probability value from the database record.

3. A system according to claim 1, wherein the program of instructions, when executed by the server processor, causes the server processor to determine a probability value for the group by calculating the probability value.

4. A system according to claim 3, wherein the program of instructions, when executed by the server processor, further causes the server processor to calculate the probability value based upon the number of members in the group.

5. A system according to claim 3, wherein the program of instructions, when executed by the server processor, further causes the server processor to calculate the probability value that is proportional to the number of members in the group.

6. A system according to claim 3, wherein the program of instructions, when executed by the server processor, further causes the server processor to calculate the probability value as a ratio of an expected daily value of the group and the value of a typical transaction for the group.

7. A system according to claim 3, wherein the program of instructions, when executed by the server processor, further causes the server processor to calculate the probability value based upon a change in the group.

8. A system according to claim 7, wherein the group has a spending history and wherein the change in the group comprises one of a change in the number of members in the group, passage of a period of time, and a change in the spending history.

9. A system according to claim 1, wherein the data to modify a term of the cashless transaction changes the amount of the cashless transaction by one of reducing the amount and reducing the amount to zero.

10. A system according to claim 1, wherein, if the random number is one of less than and equal to the probability value, the program of instructions, when executed by the server processor, further causes the server processor to calculate an amount of a reward, and to transmit to one of the merchant and the customer, during the cashless transaction, data to subtract the amount of the reward from the amount of the cashless transaction.

11. A method for providing a reward during a cashless transaction between a merchant and a customer using a cashless transaction card account number, the method comprising, during a cashless transaction:
receiving a request to authorize a cashless transaction for the customer cashless transaction account number;
accessing a database containing a database record for a group comprised of at least one member, the database record comprising an entry containing a cashless transaction account number for the at least one member;
determining if there is an entry in the database for the customer cashless transaction account number;
when there is an entry in the database for the customer cashless transaction account number, determining a probability value for the group;
generating a random number;
determining if the random number is one of less than and equal to the probability value; and
if the random number is one of less than and equal to the probability value, transmitting to one of the merchant and the customer, during the cashless transaction, data to modify a term of the cashless transaction.

12. A method according to claim 11, further comprising determining a probability value for the group by obtaining the probability value from the database record.

13. A method according to claim 11, further comprising determining a probability value for the group by calculating the probability value.

14. A method according to claim 13, further comprising calculating the probability value based upon the number of members in the group.

15. A method according to claim 13, further comprising calculating the probability value that is proportional to the number of members in the group.

16. A method according to claim 13, further comprising calculating the probability value as a ratio of an expected daily value of the group and the value of a typical transaction for the group.

17. A method according to claim 13, further comprising calculating the probability value based upon a change in the group.

18. A method according to claim 17, wherein the group has a spending history and wherein the change in the group comprises one of a change in the number of members in the group, passage of a period of time, and a change in the spending history.

19. A method according to claim 11, further comprising transmitting to one of the merchant and the customer, during the cashless transaction, data to change the amount of the cashless transaction by one of reducing the amount and reducing the amount to zero.

20. A method according to claim 11, wherein, if the random number is one of less than and equal to the probability value, the method further comprising calculating an amount of a reward, and transmitting to one of the merchant and the customer, during the cashless transaction, data to subtract the amount of the reward from the amount of the cashless transaction.
